(19) United States
(12) Patent Application Publication
(10) Pub. No.: US 2006/0006804 A1
(43) Pub. Date: Jan. 12, 2006

(54) Dielectric barrier discharge lamp

(76) Inventors: Lajos Reich, Paskal u. (HU); Istvan Maros, Galopp u. (HU); Laszlo Bankuti, Erdosor u. (HU); Jozsef Tokes, Kaposztasmegyeri u. (HU); Zoltan Nagy, Regitemeto u. (HU)

Correspondence Address: Timothy E. Nauman;FAY, SHARPE, FAGAN, MINNICH & McKEE, LLP, 7th Floor, 1100 Superior Avenue, Cleveland, OH, 44114, US

(21) Appl. No.: 10/885,347

(22) Filed: Jul. 6, 2004

(51) Int. Cl. H01J 11/00

(52) U.S. Cl. 313/607

(57) ABSTRACT

A dielectric barrier discharge lamp comprises multiple tubular discharge vessels of a substantially equivalent size and having a principal axis. Each discharge vessel encloses a discharge volume filled with a discharge gas. The discharge vessels are arranged substantially parallel to their principal axis and adjacent to each other. The lamp also comprises a first set of interconnected electrodes and a second set of interconnected electrodes. The electrodes are isolated from the discharge volume by at least one dielectric layer. At least one of the dielectric layers is constituted by the wall of the discharge vessel, and the electrodes of at least one electrode set are located between the discharge vessels. In one embodiment, the discharge vessels are adjacent to each other in a lattice, and the first and second electrode sets are located between the discharge vessels in interstitial voids of the lattice. In another embodiment, the discharge vessels are arranged adjacent to each other along generatrices of a prism.

### BACKGROUND OF THE INVENTION

This invention relates to a dielectric barrier discharge lamp.

The majority of the presently known and commercially available low pressure discharge lamps are so-called compact fluorescent lamps. These lamps have a gas fill which also contains small amounts of mercury. Since mercury is a highly poisonous substance, novel types of lamps are being recently developed. One promising candidate to replace mercury-filled fluorescent lamps is the so-called dielectric barrier discharge lamp (shortly DBD lamp). Besides eliminating the mercury, it also offers the advantages of long lifetime and negligible warm-up time.

As explained in detail, for example, in U.S. Pat. No. 6,060,828, the operating principle of DBD lamps is based on a gas discharge in a noble gas (typically Xenon). The discharge is maintained through a pair of electrodes, between which there is at least one dielectric layer. An AC voltage of a few kV with a frequency in the kHz range is applied to the electrode pair. Often, multiple electrodes with a first polarity are associated to a single electrode having the opposite polarity. During the discharge, excimers (excited molecules) are generated in the gas, and electromagnetic radiation is emitted when the meta-stable excimers dissolve. The electromagnetic radiation of the excimers is converted into visible light by suitable phosphors, in a physical process similar to that occurring in mercury-filled fluorescent lamps. This type of discharge is also referred to as dielectrically impeded discharge.

As mentioned above, DBD lamps must have at least one electrode set which is separated from the discharge gas by a dielectric. It is known to employ the wall of the discharge vessel itself as the dielectric. In this manner, a thin film dielectric layer may be avoided. This is advantageous because a thin film dielectric layer is complicated to manufacture and it is prone to deterioration. Various discharge vessel-electrode configurations have been proposed to satisfy this requirement. U.S. Pat. No. 5,994,849 discloses a planar configuration, where the wall of the discharge vessel acts as a dielectric. The electrodes with opposite polarities are positioned alternating to each other. The arrangement has the advantage that the discharge volume is not covered by electrodes from at least one side, but a large proportion of the electric field between the electrodes is outside the discharge vessel. On the other hand, a planar lamp configuration can not be used in the majority of existing lamp sockets and lamp housings, which were designed for traditional incandescent bulbs.

U.S. Pat. Nos. 6,060,828 and No. 5,714,835 disclose substantially cylindrical DBD light sources which are suitable for traditional screw-in sockets. These lamps have a single internal electrode within a discharge volume, which is surrounded on the external surface of a discharge vessel by several external electrodes. It has been found that such an electrode configuration does not provide a sufficiently homogenous light, because the discharge within the relatively large discharge volume tend to be uneven. Certain volume portions are practically completely devoid of an effective discharge, particularly those volume portions which are further away from both electrodes.

U.S. Pat. No. 5,763,999 and U.S. patent application Publication No. US 2002/0067130 A1 disclose DBD light source configurations with an elongated and annular discharge vessel. The annular discharge vessel is essentially a double-walled cylindrical vessel, where the discharge volume is confined between two concentric cylinders having different diameters. A first set of electrodes is surrounded by the annular discharge vessel, 25 so that the first set of electrodes is within the smaller cylinder, while a second set of electrodes is located on the external surface of the discharge vessel, i. e. on the outside of the larger cylinder.

This known arrangement has the advantage that the shape of the lamp is closer to 30 the traditional incandescent and more recent fluorescent lamps. Further, none of the electrode sets need any particular insulation from the discharge volume, because the walls of the discharge vessel provide stable and reliable insulation. However, the annular shape of the discharge vessel causes certain manufacturing problems, and the external electrodes are visually unattractive, and remain visible even if the discharge vessel is covered by a further external translucent envelope.

U.S. Pat. No. 6,049,086 discloses a DBD radiator which comprises multiple parallel arranged gas tubes. The gas tubes act as discharge tubes, and electrodes are placed between the gas tubes, so that the walls of the gas tubes act as the dielectric. This known radiator is used as a high power planar UV source, and the arrangement has been partly proposed to permit the flow of a coolant either in the vicinity of or directly contacting the gas tubes. However, it has not been suggested to arrange the gas tubes to form a light source body that is substantially cylindrical, and resembles usual incandescent or fluorescent light sources.

Accordingly, there is a need for a DBD lamp configuration with an improved discharge vessel-electrode configuration, which disturbs less the aesthetic appearance of the lamp. There is also need for an improved discharge vessel-electrode configuration which ensures that the electric field and the discharge within the available discharge volume is homogenous and strong, and thereby substantially the full volume of a lamp may be used efficiently. It is sought to provide a DBD lamp, which, beside having an improved discharge vessel arrangement, is relatively simple to manufacture, and which does not require expensive thin-film dielectric layer insulations of the electrodes and the associated complicated manufacturing facilities. Further, it is sought to provide a discharge vessel configuration, which readily supports different types of electrode set configurations, according to the characteristics of the used discharge gas, exciting voltage, frequency and exciting signal shape.

### SUMMARY OF THE INVENTION

In an exemplary embodiment of the present invention, there is provided a dielectric barrier discharge lamp, which comprises multiple tubular discharge vessels of a substantially equivalent size and having a principal axis. Each discharge vessel encloses a discharge volume filled with a discharge gas. The discharge vessels are arranged substantially parallel to their principal axis and adjacent to each other. The lamp also comprises a first set of interconnected electrodes and a second set of interconnected electrodes, and the electrodes are isolated from the discharge volume by at least one dielectric layer. At least one of the dielectric layers is constituted by the wall of the discharge vessel. The electrodes of at least one electrode set are located between the discharge vessels.

In an exemplary embodiment of another aspect of the invention, there is provided a dielectric barrier discharge lamp, which comprises multiple tubular discharge vessels of a substantially equivalent size and having a principal axis. Each discharge vessel encloses a discharge volume filled with discharge gas. The discharge vessels are arranged substantially parallel to their principal axis and adjacent to each other in a lattice. The lamp further comprises a first set of interconnected electrodes and a second set of interconnected electrodes, which are isolated from the discharge volume by at least one dielectric layer. At least one of the dielectric layers is constituted by the wall of the discharge vessel. The first and second electrode sets are located between the discharge vessels in interstitial voids of the lattice.

In an exemplary embodiment of yet another aspect of the invention, there is provided a dielectric barrier discharge lamp, which comprises multiple tubular discharge vessels of a substantially equivalent size and having a principal axis. Each discharge vessel encloses a discharge volume filled with discharge gas. The discharge vessels are arranged substantially parallel to their principal axis and adjacent to each other along the generatrices of a prism. The lamp also comprises a first set of interconnected electrodes and a second set of interconnected electrodes, which are isolated from the discharge volume by at least one dielectric layer. At least one of the dielectric layers is constituted by the wall of the discharge vessel.

The disclosed DBD lamps ensure that the available lamp volume is divided into multiple smaller discharge volumes. These smaller discharge volumes have a substantially equivalent size and shape, and their electrode arrangements are also quite similar. Therefore, all discharge volumes will show very similar radiation characteristics. The arrangement of multiple tubes allow the intermittent placement of electrodes, so that the lines of force of the electric field will extend into the discharge volumes, and the lamp will operate with a good efficiency. If necessary, the electrodes may be located external to the discharge vessel, and yet practically do not cover the external surface of the lamp. Further, no sealed lead-through or any dielectric covering layer film for the electrodes is required. The lamp can provide a uniform and homogenous volume discharge, and a large illuminating surface.

### BRIEF DESCRIPTION OF DRAWINGS

The invention will be now described with reference to the enclosed drawings, where

FIG. 1 is a side view of a dielectric barrier discharge lamp with an essentially tubular or cylindrical envelope enclosing multiple tubular discharge vessels,

FIG. 2 is a cross section of the envelope and the discharge vessels of the lamp shown in FIG. 1,

FIG. 3 is another cross section of the envelope and the discharge vessels of another embodiment of a DBD lamp, with a discharge vessel arrangement similar to that shown in FIG. 1,

FIG. 4 shows the arrangement of the discharge vessels and the electrodes, when taking apart the bundle of the discharge vessels substantially along the plane IV-IV of FIG. 3,

FIG. 5 is the cross section of the envelope and the discharge vessels of yet another embodiment of a DBD lamp, with an enlarged detail showing the electrodes and a single discharge vessel,

FIG. 6 illustrates yet another embodiment of the envelope and the discharge vessels with different electrode layout, in a view similar to that of FIG. 5.

### DETAILED DESCRIPTION OF THE INVENTION

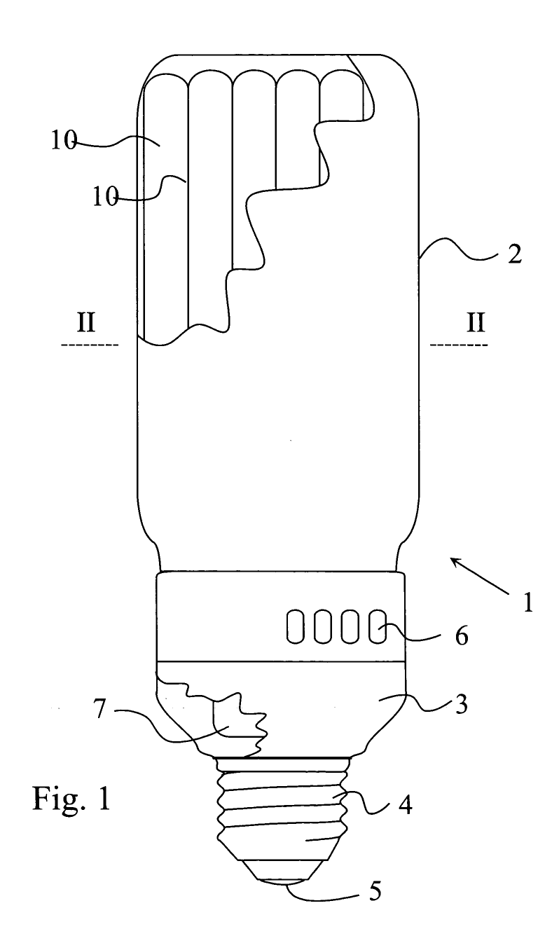

Referring now to FIG. 1, there is shown a low pressure discharge lamp 1. The lamp is a dielectric barrier discharge lamp (hereinafter also referred to as DBD lamp), with an external envelope 2 enclosing a plurality of discharge vessels 10. In the shown embodiment the external envelope 2 is substantially cylindrical, as well as the discharge vessels 10. The discharge vessels 10 and the external envelope 2 are mechanically supported by a lamp base 3, which also holds the contact terminals 4,5 of the lamp 1, corresponding to a standard screw-in socket. The lamp base also houses an AC power source 7, illustrated only schematically. The AC power source 7 is of a known type, which delivers an AC voltage of 1-5 kV with 50-200 kHz AC frequency, and need not be explained in more detail. The operation principles of power sources for DBD lamps are disclosed, for example, in U.S. Pat. No. 5,604,410. As shown in the embodiment of FIG. 1, ventilation slots 6 may be also provided on the lamp base 3.

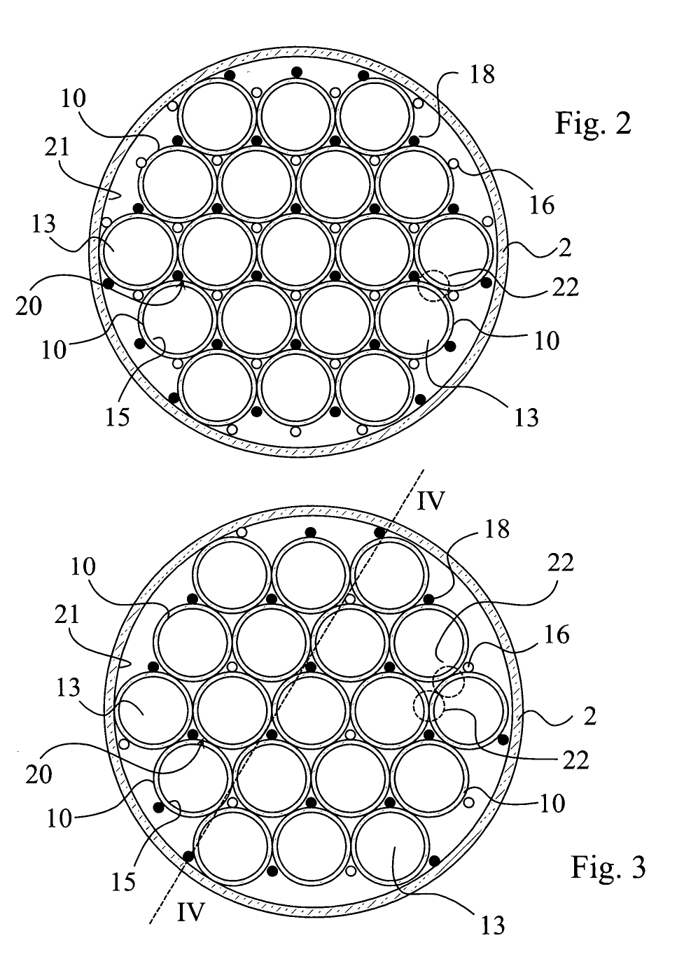

The structure and the geometrical arrangement of the discharge vessels 10 within the envelope 2 of the DBD lamp 1 is explained with reference to FIGS. 2-4.

FIGS. 2 and 3 illustrate two possible embodiments of the lamp 1 in cross section, taken along the plane II in FIG. 1. From this it is apparent that the envelope 2 encloses multiple tube-shaped discharge vessels 10, which have a substantially equivalent size. The discharge vessels 10 are arranged in a bundle, parallel to their principal axis and adjacent to each other. In the preferred embodiment shown in FIGS. 2 and 3, the discharge vessels 10 are arranged in a hexagonal lattice (resembling a honeycomb pattern). The hexagonal arrangement is preferable because a hexagonal lattice has a relatively high packing density, as compared with other periodic lattices, e. g. a square lattice. This means that the useful volume of the envelope 2 is filled most efficiently in this manner. This may be desired when the envelope 2 encloses only a relatively small number of discharge vessels 10, say seven, so that the surface of the envelope 2 is relatively close to the inner volume portions as well, and even those discharge vessels may effectively contribute to the light output which are not directly adjacent to the envelope 2.

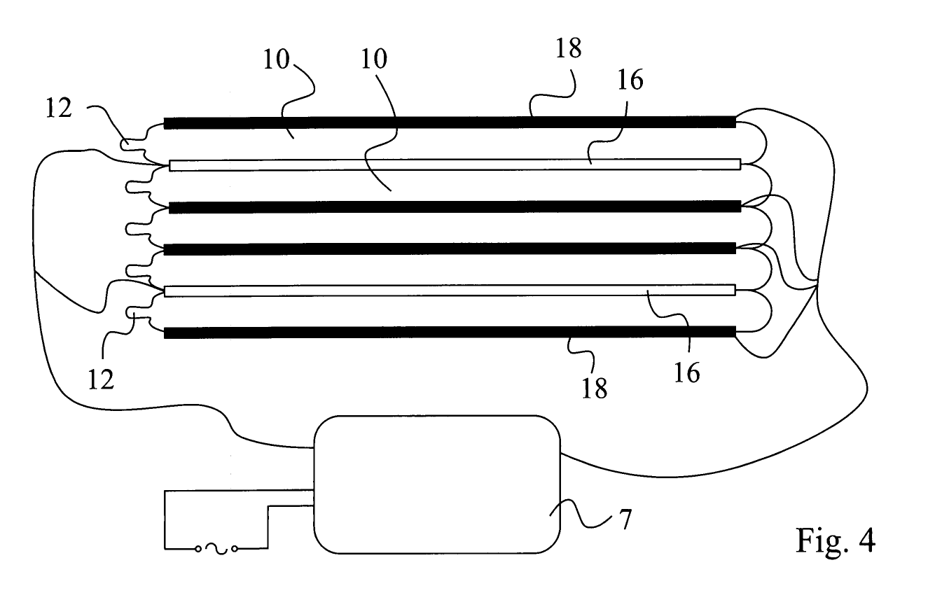

Each discharge vessel 10 encloses a discharge volume 13, which is filled with discharge gas. The discharge vessels 10 are substantially tubular, in the shown embodiment they are cylindrical, but other suitable cross sections may be selected as well. For example, an even better packing density may be achieved with tubular discharge vessels having a substantially square cross section with slightly rounded corners, to leave room for the electrodes. The discharge vessels 10 are made of glass in the shown embodiments. As shown in FIG. 4, on one end 12 of the discharge vessels 10 the remnants of an exhaust tube are visible. The exhaust tube is tipped off and thereby the discharge volume 13 within the discharge vessels 10 is sealed.

Though the envelope 2 provides a certain means for clamping together the bundle of discharge vessels 10, it is advisable to provide further fastening or clamping means, considering the mechanical properties of the discharge vessels 10. For example, the discharge vessels 10 may be glued together with any suitable and preferably translucent glue, such as GE Silicon IS-5108. Alternatively, a cushion layer, such as a translucent plastic foil may be provided between the touching surfaces 22 of the discharge vessels 10 and/or between the external envelope 2. If no glue is used, a suitable resilient clamping mechanism, such as a rubber or soft plastic band may be also used to keep the discharge vessels 10 in tight contact with each other.

The number of discharge vessels 10 within a lamp 1 may vary according to size or desired power output of the lamp 1. For example, seven, nineteen or thirty-seven discharge vessels 10 may form a hexagonal block. The chosen number is dependent on a number of factors. One of the considerations is the wall thickness of the discharge vessels 10, which also influences the properties of the discharge, but also the mechanical strength of the discharge vessels 10. These factors present contradictory demands, because a thin wall is required for an efficient discharge (when the wall acts as a dielectric layer, as explained below), while a relatively thick wall is desired to have a sufficient mechanical stability. An acceptable compromise for the wall thickness of the discharge vessels 10 is approx. 0.4-0.8 mm, preferably 0.5 mm, when the diameter of the discharge vessels is between 5-15 mm, preferably between 8-10 mm.

The dielectric barrier discharge (also termed as dielectrically impeded discharge) is generated by a first set of interconnected electrodes 16 and a second set of interconnected electrodes 18. The term “interconnected” indicates that the electrodes 16 and 18 are on a common electric potential, i. e. they are connected with each other within a set, as shown in FIG. 4. In order to ensure better overview of the two electrode sets, in the drawings electrodes 16 are white while electrodes 18 are black.

In the embodiment shown in FIG. 2, the smallest distance between two neighboring electrodes of opposite sets is approx. 3-5 mm. This distance is also termed as the discharge gap, and its value also influences the general parameters of the discharge process within the discharge vessels 10.

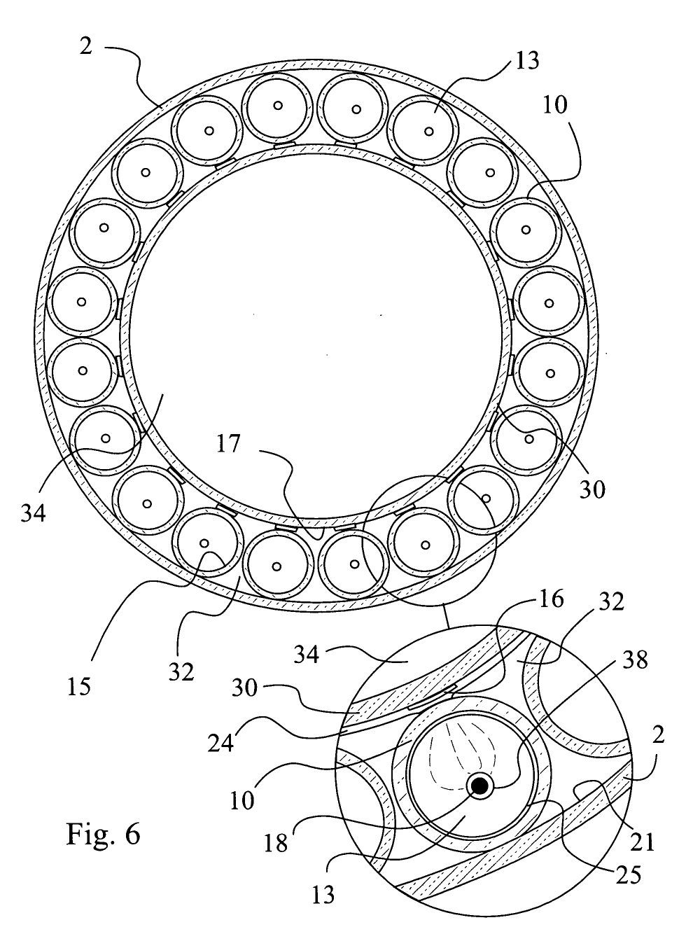

On the other hand, the electrodes 16 and 18 are isolated from the discharge volume 13 by the wall of the discharge vessel 10. More precisely, it is the wall of the inner tubular portion, which serves as the dielectric layer. As seen in FIG. 2, both the first and second set of the electrodes 16 and 18 are located external to the discharge vessels 10. Here the term “external” indicates that the electrodes 16 and 18 are outside of the sealed volume 13 enclosed by the discharge vessels 10. This means that the electrodes 16 and 18 are not only separated from the discharge volume 13 with a thin dielectric layer, but it is actually the wall of the discharge vessels 10 which separates them from the discharge volume 13, i. e. for both sets of the electrodes 16 and 18 the wall of the discharge vessel 2 acts as the dielectric layer of a dielectrically impeded discharge. Therefore, it is desirable to use a relatively thin wall. There is no need for further dielectric layers between the glass walls and the electrodes, or covering the electrodes, though the use of such dielectric is not excluded in certain embodiments, as will be shown with reference to FIG. 6.

As shown in FIGS. 2 and 3, the electrodes 16 and 18 of both the first and second electrode sets are placed in the interstitial voids 20 of the hexagonal lattice. In the embodiment shown in FIG. 2, there is one electrode in each of the interstitial voids 20, and there are an equal number of positive and negative electrodes. This means that the electrodes 16 and 18 are arranged so that one electrode associated to a set is surrounded by three electrodes associated to the other set. At the same time, each electrode is separated from the nearest electrode of opposing polarity by a dielectric (the touching wall sections 22 of the discharge vessels 10). Also, on the average there is one electrode pair for each discharge vessel. In this manner, the electrodes 16 and 18 are distributed along the circumference of the discharge vessels 10 substantially uniformly and alternating with each other. However, in this configuration, the lines of force of the strongest electric fields (those between two nearest electrodes of opposing polarity) pass only at the circumference of the discharge vessels 10, though the excitation of the gas will be more homogenous within a discharge vessel 10.

Therefore, in another preferred embodiment, which is shown in FIG. 3, the electrodes are arranged so that one electrode 16 associated to a first set is surrounded by six electrodes 18 associated to the second set, while one electrode 18 associated to the second set is surrounded by three electrodes 16 associated to the first set. From this it follows that the number of anodes are half of the number of cathodes. Every second interstitial void 20 is empty, and the total number of electrodes is approximately equal to the number of discharge vessels 10. In this manner each pair of opposing electrodes 16,18 are separated by two touching wall sections 22 instead of one, while the lines of force of the electric field between the electrodes better penetrate the discharge vessels 10.

The first set of the electrodes 16 and the second set of electrodes 18 are formed as elongated conductors. For example, these elongated conductors may be formed of metal stripes or metal bands, which extend along the principal axis of the discharge vessels 10. Such electrodes may be applied onto the glass surface of some or all of the discharge vessels 10 with any suitable method, such as tampon printing or by gluing thin foil strips onto the glass surface. However, the electrodes 16,18 may be formed of thin wires as well, as shown in the embodiments in the figures.

In order to provide a visible light, the internal surface 15 of the discharge vessels 10 is covered with a phosphor layer 25 (not shown in FIGS. 2 to 4). This phosphor layer 25 is within the sealed discharge volume 13. A phosphor layer may also cover the internal surface 21 of the cylindrical envelope 2. In any case, the envelope 2 is preferably not transparent but only translucent. In this manner the relatively thin electrodes 16,18 within the envelope 2 are barely perceptible, and the lamp 1 also provides a more uniform illuminating external surface.

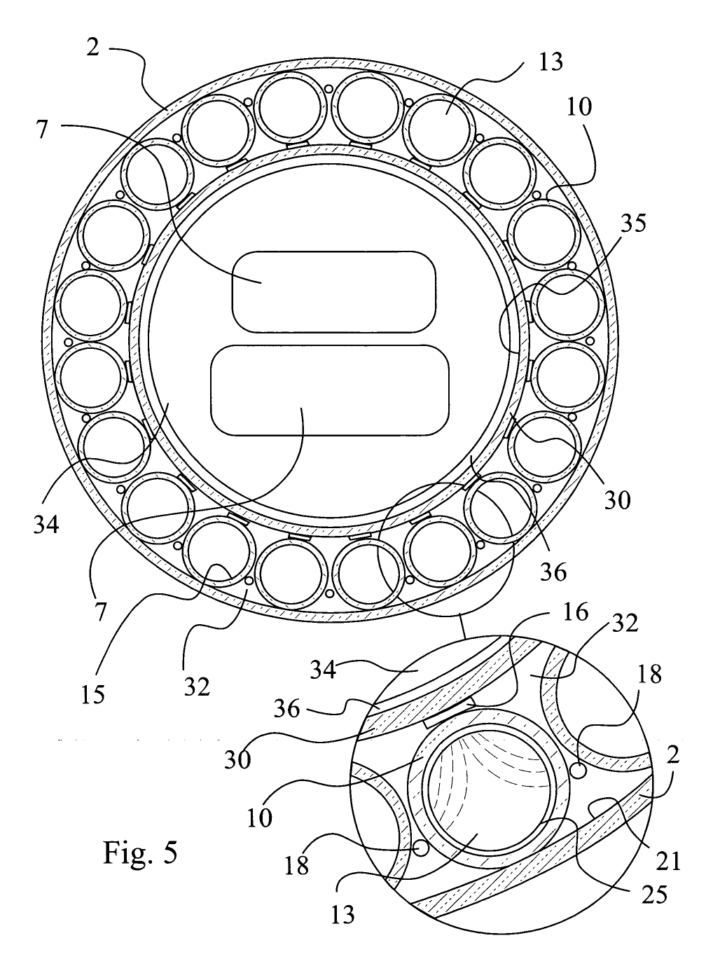

FIGS. 5 and 6 illustrate the discharge vessel arrangement of further embodiments of the DBD lamp, in a cross sectional view similar to FIGS. 2 and 3. Here, the discharge vessels 10 are arranged along the generatrices of a prism, in the shown embodiment a cylinder. The use of a circularly symmetric prism is preferred in order to have a uniform light distribution. This arrangement is suitable when the diameter of the envelope 2 is much larger than the diameter of the tubular discharge vessels 10, so that the inner discharge vessels would not provide a significant contribution to the light output. In practice the circularly symmetric arrangement is achieved by positioning the discharge vessels 10 close to each other around an inner cylinder 30, so that the principal axis of the cylindrical discharge vessels 10 remain parallel to the central axis of the inner cylinder 30 (perpendicular to the plane of the drawing in FIGS. 5 and 6). The inner cylinder 30 may be manufactured of any suitable material, such as glass or plastic. The main function of this inner cylinder 30 is the mechanical support of the discharge vessels 10, in the sense that the discharge vessels 10 are confined within an annular volume 32 between the outer cylindrical envelope 2 and the inner cylinder 30.

Most preferably, as shown in FIGS. 5 and 6, the inner cylinder 30 is hollow, and its inner volume 34 may be used for various purposes. For example, as shown in FIG. 5, the inner volume 34 of the inner cylinder 30 may contain the AC power source 7, and thereby the volume of the lamp base 3 may be minimized, and essentially bulk of the whole lamp 1 will be determined by the envelope 2. In this case, the inner surface 35 of the inner cylinder 30 may have a conductive layer 36, in order to shield the electromagnetic noise emanating from the AC power source 7. Alternatively, the inner cylinder 30 itself may be constructed of an electrically conductive material.

In the embodiment of the DBD lamp shown in FIG. 5, the electrodes 18 of one of the electrode sets are located between the discharge vessels 10, while the electrodes 16 of the other electrode set are placed between an associated discharge vessel 10 and the inner cylinder 30. This arrangement is clearly seen in the enlarged part of FIG. 5. This arrangement has the advantage that all the electrodes 18 are retracted from the direct vicinity of the external envelope 2, and therefore they are practically invisible through the translucent envelope 2. At the same time, the lines of force of the electric field 33 pas through the interior of the discharge vessels 10, thereby contributing to an intensive discharge.

Similarly to the embodiments shown in FIGS. 2 and 3, a phosphor layer 25 covers the internal surface 15 of the discharge vessels 10. The composition of such a phosphor layer 25 is known per se. This phosphor layer 25 converts the UV radiation of the excimer de-excitation into visible light. The phosphor layer 25 is applied to inner surface of the discharge vessels 10 before they are sealed. It is also possible to cover the internal surface 21 of the external envelope 2 with a similar phosphor layer, though in this case the discharge vessels 10 must be substantially non-absorbing in the UV range, otherwise the lamp will have a low efficiency. Alternatively, as in the embodiment shown in FIG. 6, the outward surface 17 of the inner cylinder 30 may be covered with a reflective layer 24 reflecting in either in the UV or visible wavelength ranges, or in both ranges. Such a reflective layer 24 also improves the luminous efficiency of the lamp 1.

In the embodiment shown in FIG. 6, the electrodes 16 associated to one of the electrode sets are located between the discharge vessels 10 and the inner cylinder 30, while the electrodes 18 associated to the other electrode set are located within the discharge vessels 10. In this case, it is possible to provide the electrodes 18 within the discharge vessels 10 with a second dielectric layer 38, as shown in FIG. 6.

In all embodiments shown, it is preferred that the wall thickness of the discharge vessels 10 should be substantially constant, mostly from a manufacturing point of view, and also to ensure an even discharge within the discharge vessel 10 along their full length.

Finally, it must be noted that the parameters of the electric field and the efficiency of the dielectric barrier discharge within the discharge volume 13 also depend on a number of other factors, such as the excitation frequency, exciting signal shape, gas pressure and composition, etc. These factors are well known in the art, and do not form part of the present invention.

The proposed electrode-discharge vessel arrangement has a number of advantages. Firstly, the tubular thin-walled discharge vessels 10 are manufactured more easily than a discharge vessel with a large internal surface and a dielectric layer within the discharge vessel. The voids between the tubular discharge vessels 10 are very suitable for the placement of the electrodes, because the lines of force of the electric field will go through the discharge volume. On the other hand, even if the discharge processes and thereby the light generation within the single discharge volumes 13 are not or not sufficiently homogenous, the overall homogenous light output and general visual appearance of the lamp is still ensured, because each discharge vessel 10 within the envelope 2 will perform more or less equally.

The invention is not limited to the shown and disclosed embodiments, but other elements, improvements and variations are also within the scope of the invention. For example, it is clear for those skilled in the art that a number of other forms of the envelope 2 may be applicable for the purposes of the present invention, for example, the envelope may have a triangular or square cross-section. The general cross-section of the tubular discharge vessels need not be strictly circular either (as with a cylindrical discharge vessel), for example, they may be triangular or rectangular, or simply quadrangular in general. Conversely, the discharge vessels may be arranged in various types of lattices, such as square (cubic) or even non-periodic lattices, though the preferred embodiments foresee the use of periodic lattices with substantially equally shaped, uniformly sized discharge vessels. Also, the shape and material of the electrodes may vary, and not only a single electrode, but also one or more electrode pairs may be within the discharge volume in each discharge vessel.

1. A dielectric barrier discharge lamp comprising
a/ multiple tubular discharge vessels of a substantially equivalent size and having a principal axis, each discharge vessel enclosing a discharge volume filled with a discharge gas, the discharge vessels being arranged substantially parallel to their principal axis and adjacent to each other,
b/ a first set of interconnected electrodes and a second set of interconnected electrodes, the electrodes being isolated from the discharge volume by at least one dielectric layer, at least one of the dielectric layers being constituted by the wall of the discharge vessel, the electrodes of at least one electrode set being located between the discharge vessels.

2. The lamp of claim 1, in which the discharge vessels are confined within a substantially cylindrical envelope.

3. The lamp of claim 1, in which the discharge vessels are arranged in a hexagonal lattice

4. The lamp of claim 3, in which the electrodes of both the first and second electrode sets are placed in interstitial voids of the hexagonal lattice.

5. The lamp of claim 4, in which the electrodes are arranged so that one electrode associated to a set is surrounded by three electrodes associated to the other set.

6. The lamp of claim 4, in which the electrodes are arranged so that one electrode associated to a first set is surrounded by six electrodes associated to the second set, while one electrode associated to the second set is surrounded by three electrodes associated to the first set.

7. The lamp of claim 1, in which the discharge vessels are arranged along generatrices of a prism.

8. The lamp of claim 7, in which the discharge vessels are confined within an annular volume between an outer cylindrical envelope and an inner cylinder.

9. The lamp of claim 8, in which the inner cylinder is hollow.

10. The lamp of claim 9, in which the inner cylinder contains an AC power source.

11. The lamp of claim 8, in which the electrodes of one of the electrode sets are located between the discharge vessels, while the electrodes of the other electrode set are placed between an associated discharge vessel and the inner cylinder.

12. The lamp of claim 8, in which the electrodes associated to one of the electrode sets are located externally to the discharge vessels, while the electrodes associated to the other electrode set are located within the discharge vessels.

13. The lamp of claim 1, in which the first and second sets of electrodes are formed as elongated conductors extending substantially parallel to a principal axis of the discharge vessels.

14. The lamp of claim 13, in which the elongated conductors are metal stripes or foils or metal wires.

15. The lamp of claim 2, in which a phosphor layer covers any of at least the internal surface of the discharge vessels or the internal surface of the cylindrical envelope.

16. The lamp of claim 1, in which the discharge vessels are glued together.

17. A dielectric barrier discharge lamp comprising
a/ multiple tubular discharge vessels of a substantially equivalent size and having a principal axis, each discharge vessel enclosing a discharge volume filled with discharge gas, the discharge vessels being arranged substantially parallel to their principal axis and adjacent to each other in a lattice,
b/ a first set of interconnected electrodes and a second set of interconnected electrodes, the electrodes being isolated from the discharge volume by at least one dielectric layer, at least one of the dielectric layers being constituted by the wall of the discharge vessel, the first and second electrode sets being located between the discharge vessels in interstitial voids of the lattice.

18. The lamp of claim 17, in which the lattice is periodic.

19. The lamp of claim 18, in which the lattice is hexagonal.

20. The lamp of claim 19, in which the electrodes are arranged so that one electrode associated to a set is surrounded by three electrodes associated to the other set.

21. The lamp of claim 19, in which the electrodes are arranged so that one electrode associated to a first set is surrounded by six electrodes associated to the second set, while one electrode associated to the second set is surrounded by three electrodes associated to the first set.

22. A dielectric barrier discharge lamp comprising
a/ multiple tubular discharge vessels of a substantially equivalent size and having a principal axis, each discharge vessel enclosing a discharge volume filled with discharge gas, the discharge vessels being arranged substantially parallel to their principal axis and adjacent to each other along generatrices of a prism,
b/ a first set of interconnected electrodes and a second set of interconnected electrodes, the electrodes being isolated from the discharge volume by at least one dielectric layer, at least one of the dielectric layers being constituted by the wall of the discharge vessel.

23. The lamp of claim 22, in which the prism is a cylinder.

24. The lamp of claim 22, in which the electrodes of one of the electrode sets are located between the discharge vessels.

25. The lamp of claim 22, in which the discharge vessels are confined within an annular volume between an outer cylindrical envelope and an inner cylinder.

26. The lamp of claim 25, in which each of the electrodes of one of the electrode sets are located between an associated discharge vessel and the inner cylinder.
